(19) United States
(12) Patent Application Publication
(10) Pub. No.: US 2005/0157923 A1
(43) Pub. Date: Jul. 21, 2005

(54) Image processing system and image processing method

(76) Inventor: Mutsuji Takahashi, Shizuoka (JP)

Correspondence Address: MORGAN LEWIS & BOCKIUS LLP, 1111 PENNSYLVANIA AVENUE NW, WASHINGTON, DC, 20004, US

(21) Appl. No.: 10/514,013

(22) PCT Filed: May 14, 2003
(86) PCT No.: PCT/JP03/06023

(30) Foreign Application Priority Data
May 15, 2002 (JP) 2002-140533

(51) Int. Cl. G06K 9/00

(52) U.S. Cl. 382/168; 382/128

(57) ABSTRACT

A PET equipment comprising a detection section, signal processing section, sorter section, N information processors, host computer and switching hub. N is an integer of 2 or more. Each information processor stores the coincidence counting information from the sorter section to produce a histogram. Each information processor performs image processing based on the histogram of the coincidence counting information, dividing the histogram into N partial histograms to process them. The host computer reconstructs an image representing the spatial distribution of generation frequency of photon pairs in the measurement space based on the result of the image processing in each information processor, and displays the image on the display device.

### TECHNICAL FIELD

The present invention relates to image processing based on histogram stored in a plurality of information processors.

### BACKGROUND ART

Radiation image measurement equipment determines whether arrival of radiation detected by one of radiation detectors in the detection section is an effective event, and generates a histogram on the radiation arrival determined as an effective event to reconstruct an image representing the spatial distribution of the radiation generation frequency based on this histogram. Such radiation image measurement equipment includes a 7 camera, SPECT (Single Photon Emission Computed Tomography) and PET (Positron Emission Tomography).

In particular, PET equipment can generate an image representing the behavior of the microscopic amount of a substance in a living body (sample) by detecting photon pairs, which are generated by pair annihilation of electrons and positrons and travel in opposite directions in the sample given a positron emission isotope (RI radiation source), using the coincidence counting method. The PET equipment has a detection section including many small radiation detectors arranged around a measurement space where the sample is placed. The PET equipment detects the photon pairs having 511 keV energy, which are generated by the pair annihilation of electrons and positrons, using the coincidence counting method, and generates a histogram by storing the coincidence counting information. Then, based on the generated histogram, an image representing the spatial distribution of the photon pair generation frequency in the measurement space is reconstructed. The PET equipment plays an important role in the field of nuclear medicine. Using the PET equipment, research on living body functions and high order functions of the brain, for example, can be conducted. Such PET equipment is roughly classified into two-dimensional PET equipment and three-dimensional PET equipment.

The two-dimensional PET equipment has a detection section including a plurality of detector rings stacked along the axis direction. Each detector ring includes a plurality of radiation detectors. Shield plates are placed between the detector rings. The detection section of the two-dimensional PET equipment can perform the coincidence counting of only photon pairs which flew from a direction where the angle from the central axis of the detector ring is about 90 degrees. Hence, the coincidence counting information acquired from the detection section of the two-dimensional PET equipment and then stored, that is two-dimensional projection data, is limited to one measured by a pair of radiation detectors in the same detector ring or adjacent (or very close) detector rings. Therefore the two-dimensional PET equipment can efficiently eliminate scattering rays produced by scattering of the photon pairs generated outside the measurement space, and absorption correction and sensitivity correction can be easily performed for the two-dimensional projection data.

The three-dimensional PET equipment has a detection section including a plurality of detector rings stacked in the axis direction, and each detector ring includes a plurality of radiation detectors; however, shield plates are not placed between the detector rings. The detection section of the three-dimensional PET equipment can perform the coincidence counting of photon pairs from various directions. Hence, the coincidence counting information acquired by the detection section of the three-dimensional PET equipment and then stored, that is three-dimensional projection data, can be measured by a pair of radiation detectors in any detector rings. Therefore the three-dimensional PET equipment can perform the coincidence counting of the photon pairs at a sensitivity 5 to 10 times higher than that of the two-dimensional PET equipment.

### DISCLOSURE OF THE INVENTION

For the radiation image measurement equipment, including the above PET equipment, expansion of the measurement range and improvement of resolution are demanded. This demand makes the size of the histogram enormous, and therefore it may be impossible to store the histogram in a main memory of one information processor. In particular, in the three-dimensional PET equipment, the generation frequency of the coincidence counting information to be stored is high, which may make it impossible for one information processor to generate a histogram.

With the foregoing in view, generating a histogram using a plurality of information processors has been proposed. In the case of the radiation image measurement equipment disclosed in Japanese Patent Laid-Open No. 2001-33556, for example, the coincidence counting information is input to an information processor selected from a plurality of information processors, and each of the information processors stores the input coincidence counting information to generate a histogram. Then the histograms generated by their respective information processors are integrated and an image is reconstructed. For each information processor, a general purpose personal computer, for example, can be used, and the image processing system for integrating the histograms can be configured at low cost, since any special hardware for performing the histogramming process is unnecessary.

This image processing system, however, has a problem, that is, it takes time to transfer the histograms separately generated by the plurality of information processors to one of the information processors to integrate these histograms. This problem will now be described with reference to FIG. 12.

FIG. 12 is a diagram depicting a histogram transfer in a conventional image processing system. Here it is assumed that the image processing system includes four information processors A₀-A₃. In FIG. 12, each row indicates the information processors A₀, A₁, A₂ and A₃ sequentially from the top, and each column indicates the time t=0, T, 2T and 3T sequentially from the left. The block at the p-th row and q-th column indicates the histogram stored in the information processor Aₚ at time t=qT, where p is an integer that satisfies 0≦p≦3, and q is an integer that satisfies 0≦q≦3. Each block is displayed darker each time a histogram is cumulatively added. The information processor that has sent a histogram out may continue to store this histogram; however, in FIG. 12, the block indicating the information processor that has sent a histogram out is shown as a blank for clearness. The above time T is time required for transferring a histogram stored in one information processor to other information processors. The time required for internal processing (histogram cumulative addition processing) of each information processor is ignored, as this is much smaller than the above time T.

As FIG. 12 shows, according to a conventional image processing system, the histogram stored in the information processor A₁ is transferred to the information processor A₀ during the period from the time t=0 to the time t=T, and is cumulatively added to the histogram stored in the information processor A₀. The histogram stored in the information processor A₂ is transferred to the information processor A₀ during the period from the time t=T to the time t=2T, and is cumulatively added to the histogram stored in the information processor A₀. The histogram stored in the information processor A₃ is transferred to the information processor A₀ during the period from the time t=2T to the time t=3T, and is cumulatively added to the histogram stored in the information processor A₀. As a result, the histogram stored in the information processor A₀ at the time t=3T is the sum of all the histograms stored in the respective four information processors A₀-A₃ at the time t=0. Then an image is reconstructed based on the histogram stored in the information processor A₀.

Thus, according to a conventional image processing system, the time required for integrating histograms generated by each one of the N number of information processors is (N−1) T. As the number N of the information processors included in the image processing system increases, the time required for histogram transfer increases in proportion to the value N. The radiation image measurement equipment that includes such an image processing system has low throughput in measuring samples.

It is an object of the present invention to implement image processing in which the time required for histogram transfer is shortened.

In one aspect, this invention relates to an image processing using N number of information processors A₀-A_{N-1} (N is an integer of 2 or more). Each information processor divides one histogram into N number of partial histograms H₀-H_{N-1} and stores these partial histograms. The image processing includes first to (N−1)-th transferring the partial histograms in parallel between the information processors A₀-A_{N-1} to cumulatively add the partial histograms, and performing an image process based on the partial histograms H₀-H_{N-1} cumulatively added at the information processors A₀-A_{N-1}, respectively, by the first to (N−1)-th transferring the partial histograms. The m-th transferring (m is an integer from 1 to N−1) includes executing process c (0, J (0, m), J (0, m)), process c (1, j (1, m), J (1, m)), . . . , process c (N−1, J (N−1, m), J (N−1, m)) while transferring the J (0, m)-th, J (1, m)-th, . . . , J (N−1, m)-th partial histograms in parallel, where c (i, j, k) indicates a process of transferring the k-th partial histogram Hₖ stored in the i-th information processor Aᵢ to the j-th information processor Aⱼ to cumulatively add the transferred partial histogram Hₖ to the k-th partial histogram Hₖ stored in the j-th information processor Aⱼ, i, j and k are integers from 0 to N−1, J (n, m)=(n−m)% N, and % is a modulo operator.

The i-th partial histogram Hᵢ cumulatively added at the i-th information processor Aᵢ by the first to (N−1)-th transfer is the sum of all the i-th partial histograms Hᵢ stored in the information processors A₀-A_{N-1} before the cumulative addition. In the first to (N−1)-th transfer, a plurality of partial histograms are transferred in parallel, so that the time required for the histogram transfer will be shortened.

In another aspect, this invention relates to an image processing using N number of information processors A₀-A_{N-1} (N is an integer of 2 or more) and N number of information processors B₀-B_{N-1} which are distinct from the information processors A₀-A_{N-1}. Each of the information processors A₀-A_{N-1} divides one histogram into N number of partial histograms H₀-H_{N-1} and stores these partial histograms. The image processing includes first to (N−1)-th transferring the partial histograms in parallel between the information processors to cumulatively add the partial histograms, and performing an image process based on the partial histograms H₀-H_{N-1} cumulatively added at the information processors B₀-B_{N-1}, respectively, by the first to (N−1)-th transferring the partial histograms. The m-th transferring the partial histograms (m is an integer from 1 to N−1) includes executing process d (0, J (0, m), J (0, m)), process d (1, J (1, m), J (1, m)), . . . , process d (N−1, J (N−1, m), J (N−1, m)) while transferring the J (0, m)-th, J (1, m)-th, . . . , J (N−1, m)-th partial histograms in parallel, where d (i, j, k) indicates a process of transferring the k-th partial histogram Hₖ stored in the i-th information processor Aᵢ to the j-th information processor Bⱼ to cumulatively add the transferred partial histogram Hₖ to the k-th partial histogram Hₖ stored in the j-th information processor Bⱼ, i, j and k are integers from 0 to N−1, J (n, m)=(n−m)% N, and % is a modulo operator.

The i-th partial histogram Hᵢ cumulatively added at the i-th information processor Bᵢ by the first to (N−1)-th transfer is the sum of all the i-th partial histograms Hᵢ stored in the information processors A₀-A_{N-1} before the cumulative addition. In the first to (N−1)-th transfer, a plurality of partial histograms are transferred in parallel, so that the time required for the histogram transfer will be shortened.

A plurality of the image processes based on their respective partial histograms H₀-H_{N-1} cumulatively added by the first to (N−1)-th transferring the partial histograms may be performed in parallel.

The one histogram may include radiation generation frequency data. The performing the image process may include reconstructing an image representing a spatial distribution of the radiation generation frequency based on the partial histograms H₀-H_{N-1} cumulatively added by the first to (N−1)-th transferring the partial histograms.

In still another aspect, this invention relates to radiation image measurement equipment comprising a detection section having a plurality of radiation detectors for detecting arrival of radiation from a measurement space; a signal processing section for determining whether the arrival of radiation detected by one of the radiation detectors is an effective event, and outputting data including information on the arrival of radiation determined as an effective event; and a system for performing the above image processing. When the data is output from the signal processing section, the information processor selected from the information processors A₀-A_{N-1} receives the data from the signal processing section. Each of the information processors A₀-A_{N-1} generates the partial histograms H₀-H_{N-1} based on the data received from the signal processing section, and stores these partial histograms.

Since this equipment uses the above image processing that shortens the time required for the histogram transfer, this equipment is able to acquire a radiation image quickly.

The detection section may have a plurality of detector rings stacked along the axis direction. Each detector ring may include the radiation detectors arranged in a ring shape. Identification numbers may be assigned to the detector rings sequentially along the axis direction. Determining whether the arrival of radiation is an effective event may include determining whether a pair of photons, which are generated by pair annihilation of an electron and a positron and travel in opposite directions, have been detected by a pair of the radiation detectors. When it is determined that a pair of photons have been detected by a pair of the radiation detectors, the signal processing section may output a coincidence counting data that identifies the pair of the radiation detectors. The radiation image measurement equipment may further comprise a sorter interposed between the signal processing section and the image processing system. The sorter may receive the coincidence counting data from the signal processing section to select one of the information processors A₀-A_{N-1} according to the difference between the identification numbers of one or more of the detector rings including the pair of the radiation detectors, and send the coincidence counting data to the selected information processor. Each of the information processors A₀-A_{N-1} may produce the partial histograms H₀-H_{N-1} based on the coincidence counting data sent from the sorter, and store these partial histograms.

In further aspect, this invention may be a program for having a computer execute the above image processing.

In still further aspect, this invention may be a computer-readable recording medium on which a program for having a computer execute the above image processing is recorded.

In another aspect, this invention may be a computer data signal embodied in a carrier wave. The computer date signal includes an image processing program for having a computer execute the above image processing.

This invention will be made adequately clear by way of the detailed description that follows and the attached drawings. The attached drawings are simply illustrations of examples. This invention will thus not be considered as being restricted by the attached drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a diagram depicting a general configuration of the three-dimensional PET equipment according to the first embodiment;

FIG. 2 is a cross-sectional view depicting the detection section 10 of the three-dimensional PET equipment;

FIG. 3 is a flow chart depicting an overview of the operation of the three-dimensional PET equipment;

FIG. 4 is a diagram depicting the processes of steps S3ₙ and S5ₙ in the operation of the three-dimensional PET equipment.

FIG. 5 is a flow chart depicting the operation of the image processing system according to the first embodiment;

FIG. 6 is a diagram depicting histogram transfer of the first embodiment;

FIG. 7 is a flow chart depicting the operation of the image processing system according to the second embodiment;

FIG. 8 is a diagram depicting a histogram transfer of the second embodiment;

FIG. 9 is a diagram depicting a general configuration of the three-dimensional PET equipment according to the third embodiment;

FIG. 10 is a flow chart depicting the operation of the image processing system according to the third embodiment;

FIG. 11 is a diagram depicting a histogram transfer of the third embodiment; and

FIG. 12 is a diagram depicting a partial histogram transfer in a conventional image processing system.

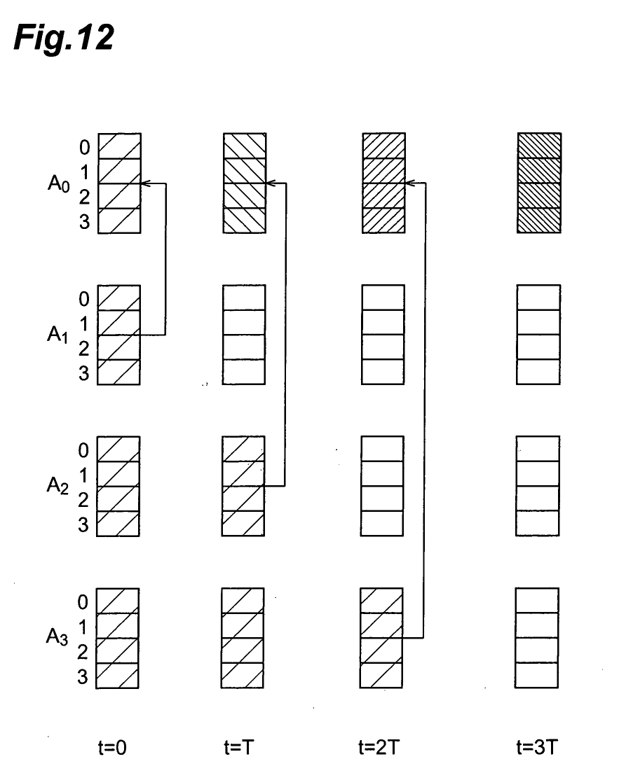

### BEST MODES FOR CARRYING OUT THE INVENTION

Embodiments of this invention will now be described in detail with reference to the attached drawings. In the description of the drawings, the same elements will be provided with the same symbols and redundant description will be omitted.

### First Embodiment

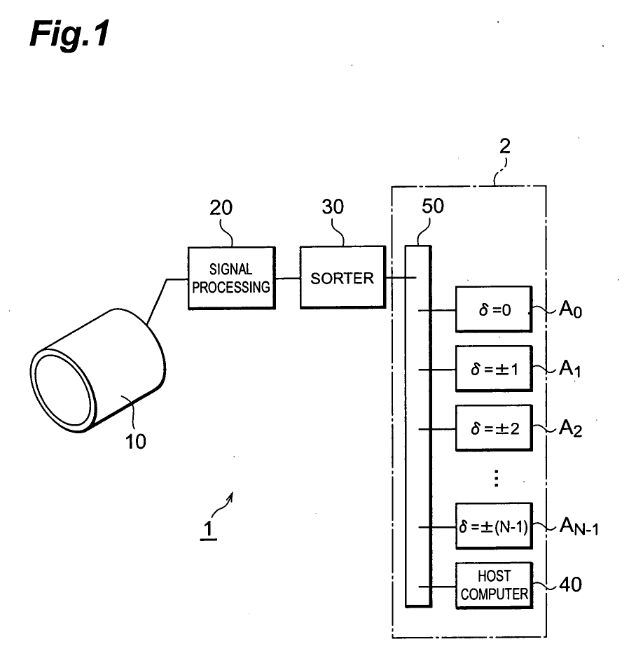

Three-dimensional PET equipment will now be described as an embodiment of the radiation image measurement equipment according to the present invention. FIG. 1 is a diagram depicting a configuration of the three-dimensional PET equipment 1 according to the present embodiment. The PET equipment 1 has a detection section 10, signal processing section 20, sorter section 30, N number of information processors A₀-A_{N-1}, host computer 40 and switching hub 50 (N is an integer of 2 or more). The information processors A₀-A_{N-1} and the host computer 40 are inter-connected via the 100 Base-T switching hub 50, constituting the image processing system 2. The sorter section 30 is also connected to the switching hub 50.

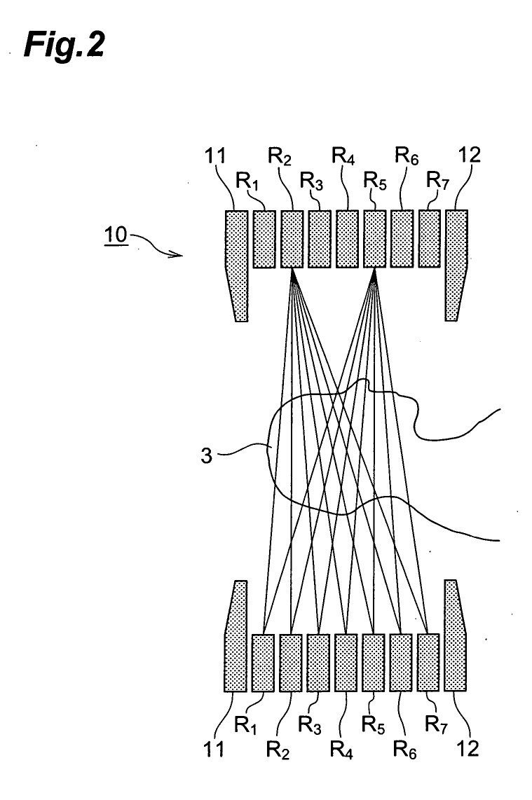

The detection section 10 includes a plurality of detector rings coaxially stacked along the axis direction. Each detector ring includes a plurality of radiation detectors. As mentioned later, the stacked detector rings are sandwiched by a pair of shield plates. There is no shield plate, however, between the detector rings. Each radiation detector detects photons which flew from the measurement space inside the detection section 10, and outputs the photon detection data which has a value according to the energy of the photon. Details of the detection section 10 will be described later with reference to FIG. 2.

The signal processing section 20 receives electric signals, which are output from one of the radiation detectors included in the detection section 10, and determines whether the arrival of the radiation detected by that radiation detector is an effective event. More specifically, the signal processing section 20 receives the photon detection data which is output from each radiation detector included in the detection section 10, and determines whether a pair of radiation detectors detected a pair of photons, which are generated by pair annihilation of an electron and a positron and travel in opposite directions, based on the photon detection data. And when it is determined that a pair of radiation detectors detected a pair of photons, the signal processing section 20 outputs the data for identifying the pair of radiation detectors, that is, the coincidence counting information.

The sorter section 30 receives the coincidence counting information from the signal processing section 20, and sends this coincidence counting information to an information processor Aₙ of the information processors A₀-A_{N-1} via the switching hub 50, where n is an integer of no less than 0 and less than N. The sorter section 30 sends the coincidence counting information to the information processor Aₙ when “ring difference”, which is one information included in the coincidence counting information, equals the value n. Identification numbers are assigned to the detector rings, which are stacked in the detection section 10, sequentially along the axis direction. The ring difference is the difference of the identification numbers assigned to the pair of radiation detectors that have detected the photon pair. If the stacked detector rings are indicated as R₁, R₂, R₃, . . . , then the ring difference is p−q when the detector rings, including the pair of radiation detectors that have detected the photon pair, are Rₚ and R_{q}.

Each information processor Aₙ stores the coincidence counting information from the sorter section 30, and produce a histogram. And each information processor Aₙ executes image processing based on this histogram of the coincidence counting information. At this time, each information processor Aₙ divides the histogram into N number of partial histograms H₀-H_{N-1} and processes these partial histograms. The host computer 40 reconstructs an image which represents the spatial distribution of the photon pair generation frequency in the measurement space based on the result of the image processing in each information processor Aₙ, and displays the image on a display device.

FIG. 2 is a cross-sectional view of the detection section 10 of the three-dimensional PET equipment 1. FIG. 2 shows the cross-section when the detection section 10 is cut along the plane which includes the central axis of the detection section 10. The detection section 10 has detector rings R₁-R₇ which are stacked between the shield 11 and the shield 12. Each one of the detector rings R₁-R₇ has a plurality of radiation detectors which are arranged in a ring shape on a plane perpendicular to the central axis. Each radiation detector is a scintillation detector where such a scintillator as BGO (Bi₄Ge₃O₁₂) and a photo-multiplier are combined, and detects the photons which flew and arrived from the measurement space including the central axis. Unlike the case of two-dimensional PET equipment, slice septa are not installed in the three-dimensional PET equipment 1. The detection section 10 can perform the coincidence counting of photon pairs which fly from various directions. In other words, the coincidence counting information, which is acquired by the detection section 10 and then stored, can be measured by the pair of radiation detectors included in arbitrary detector rings.

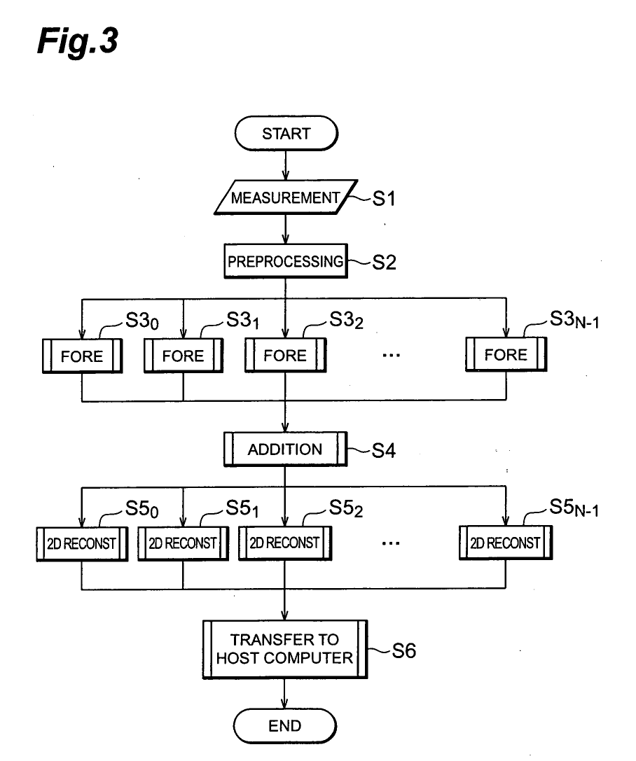

FIG. 3 is a flow chart depicting an overview of the operation of the three-dimensional PET equipment 1. In step S1, emission measurement is performed. In this emission measurement, a sample 3 to which an RI radiation source is given is placed in the measurement space inside the detection section 10 (see FIG. 2). The coincidence counting information detected by the detection section 10 is sent to any information processor Aₙ of N number of information processors A₀-A_{N-1} via the signal processing section 20, sorter section 30 and switching hub 50, and is stored in the information processor Aₙ. Consequently, the histogram of the coincidence counting information during emission measurement is generated in each information processor Aₙ.

Before or after this emission measurement, transmission measurement and blank measurement are performed. In the transmission measurement, the sample 3 to which the RI radiation source is not given is placed in the measurement space. And in the measurement space, the calibration radiation source rotates around the sample 3, the coincidence counting information detected by the detection section 10 at this time is stored, and the histogram of the coincidence counting information is generated. In the blank measurement, the calibration radiation source rotates in the measurement space without placing the sample 3 in the measurement space, the coincidence counting information detected by the detection section 10 at this time is stored, and the histogram of the coincidence counting information is generated.

At the next step S2, a pre-process is performed. In this pre-process, scattering correction, absorption correction and sensitivity correction are performed for the histogram of the coincidence counting information at the emission measurement based on the histograms of the coincidence counting information at the transmission measurement and at the blank measurement respectively.

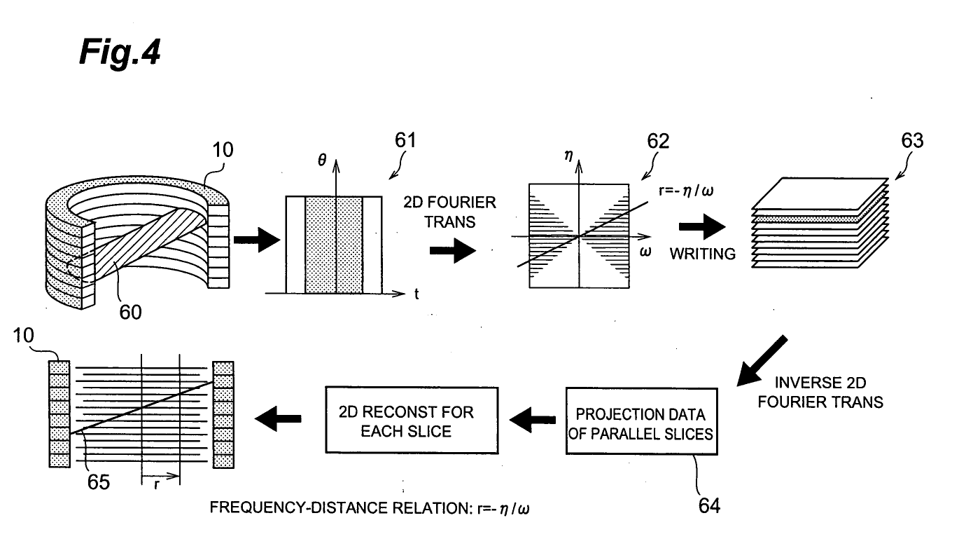

After step S2, processes of steps S3₀-S3_{N-1} are performed in parallel. The process of each step S3, is performed by the corresponding information processor Aₙ. In each step S3ₙ, the histogram of the coincidence counting information corrected in step S2 is processed by the Fourier Rebinning (FORE) method. Details of this process content will be described later with reference to FIG. 4.

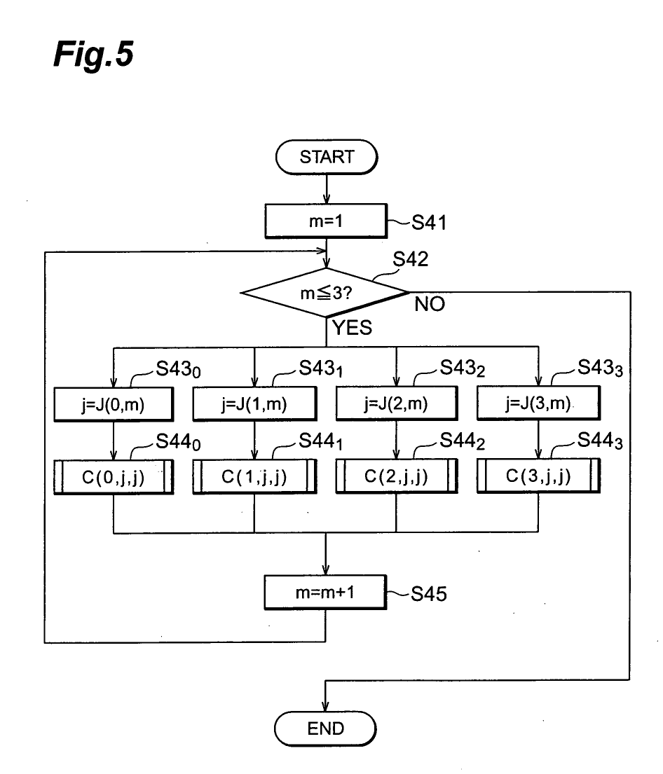

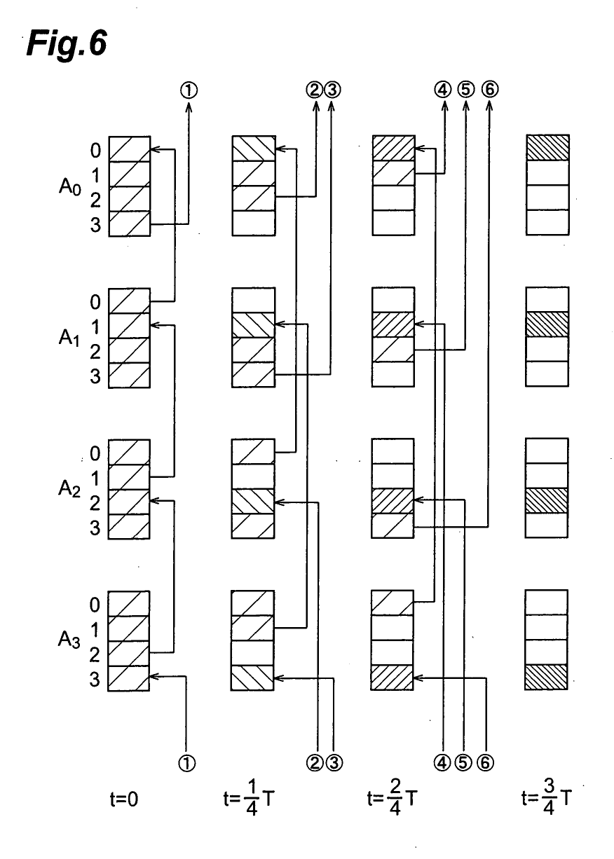

In the subsequent step S4, the histogram processed in each steps S3ₙ is divided into N number of partial histograms H₀-H_{N-1}, and these partial histograms are stored in the information processor Aₙ. Then the n-th histograms Hₙ separately stored in the N number of information processors A₀-A_{N-1} are added. Details of this process will be described later with reference to FIGS. 5 and 6.

After step S4, processes of steps S5₀-S5_{N-1} are performed in parallel. The process of each step S5ₙ is performed by the corresponding information processor Aₙ. In each step S5ₙ, image reconstruction is performed based on the histogram obtained in step S4.

In the subsequent step S6, the images reconstructed in their respective steps S5ₙ are sent from the information processors Aₙ to the host computer 40, and then a reconstruction image is displayed on the display device at the host computer 40.

FIG. 4 is a diagram depicting the processes of steps S3n and S5n (FORE method) in the operation of the three-dimensional PET equipment 1. With the FORE method, projection data 61 acquired for a projection 60 inclined with respect to the direct plane (the plane of a single detector ring), that is, the histogram of the coincidence counting information, is two-dimensional Fourier transformed for variables t and θ, where t is a position coordinate of the projection, and θ is an azimuth of the projection. By this Fourier transform, the two-dimensional Fourier transform map 62 is acquired for variables η and Ω. The two-dimensional Fourier transform map 62 is transformed into the two-dimensional Fourier transform maps 63 of a plurality of the direct planes using the frequency—distance relation, that is “r=−η/ω”. The two-dimensional Fourier transform map 63 of each direct plane is two-dimensional inverse Fourier transformed. Consequently, the projection data of the direct planes, that is, histograms 64 of the coincidence counting information, are acquired. Then a two-dimensional image reconstruction process is performed for the projection data of each direct plane, and a reconstruction image 65 is acquired. Step S3n is a process up to acquiring the histograms 64 of the coincidence counting information by the above two-dimensional inverse Fourier transform. Step S4 is a process for adding the histograms 64. Step S5n is a process of acquiring the reconstruction image 65 based on the added histogram.

Operation of the image processing system 2 will now be described. It is assumed that the image processing system 2 includes the four information processors A₀-A₃ hereinafter. In each information processor Aₙ, the partial histograms H₀-H₃ generated by equally dividing the original histogram into four are stored.

The operation of the image processing system 2 that will be described with reference to FIG. 5 and FIG. 6 is the content of the process of step S4 shown in FIG. 3. FIG. 5 is a flow chart depicting the operation of the image processing system 2 in the present embodiment. FIG. 6 is a diagram depicting the histogram transfer according to the present embodiment.

Process “j=J(n, m)” shown in each of steps S43₀-S43₃ in FIG. 5 is a process of determining the value “j” according to the functional equation “J (n, m)=(n−m)% N”. The operator “%” indicates a modulo operator. As described above, N=4 in the present embodiment. When “a” is an integer and “b” is a positive integer, then “a % b” is a value produced by subtracting the maximum multiple of “b” from “a”, where the maximum multiple of “b” is not greater than “a”. For example, “−3% 4=1”, “−2% 4=2”, “−1% 4=3” and “0% 4=0”. The process shown in each of steps S44₀-S44₃ can generally be represented by c(i, j, k). Process c (i, j, k) is a process of transferring the k-th partial histogram Hₖ stored in the i-th information processor Aᵢ to the j-th information processor Aⱼ to cumulatively add the transferred k-th partial histogram Hₖ to the k-th partial histogram Hₖ stored in the j-th information processor Aⱼ, where i, j and k are an integer from 0 to 3, respectively.

In FIG. 6, each row indicates the information processor A₀, A₁, A₂ and A₃ sequentially from the top, and each column indicates the time t=0, T/4, 2T/4 and 3T/4 sequentially from the left. The block in the p-th row and q-th column indicates a histogram which is stored in the information processor Aₚ at the time t=qT/4, where p is an integer that satisfies 0≦p≦3, and q is an integer that satisfies 0≦q≦3. Each block is displayed darker each time a histogram is cumulatively added. The information processor that has sent a histogram out may continue to store this histogram, but in FIG. 6, the block which indicates the information processor that has sent a histogram out is shown as a blank for clearness. The above mentioned time T is time required for transferring all the histograms stored in one information processor to other information processors. The time required for the internal process (the histogram cumulative addition process) of each information processor is ignored, since this is much smaller than the above mentioned time T.

At the time t=0, all the processes of steps S3₀-S3₃ have been completed, and the histogram stored in each information processor Aₙ has been equally divided into four partial histograms H₀-H₃. According to the flow shown in FIG. 5, processes in step S4 are performed. In step S41, the value m is set to 1, and after step S42, steps S43₀-S43₃ are executed in parallel. Steps S44₀-S44₃ are also executed in parallel, then in step S45, the value m is incremented by 1, and the processing returns to step S42. The m-th transfer step (m=1, 2 or 3) includes steps S43₀-S43₃ and steps S44₀-S44₃.

During the period of the first transfer step from the time t=0 to the time t=T/4, the histograms are transferred in parallel for process c (0, 3, 3), process c (1, 0, 0), process c (2, 1, 1) and process c (3, 2, 2), and cumulative addition is performed. In other words, in process c (0, 3, 3), the partial histogram H₃ stored in the information processor A₀ is transferred to the information processor A₃, and is cumulatively added to the partial histogram H₃ stored in the information processor A₃. In process c (1, 0, 0), the partial histogram H₀ stored in the information processor A₁ is transferred to the information processor A₀, and is cumulatively added to the partial histogram H₀ stored in the information processor A₀. In process c (2, 1, 1), the partial histogram H₁ stored in the information processor A₂ is transferred to the information processor A₁, and is cumulatively added to the partial histogram H₁ stored in the information processor A₁. In process c (3, 2, 2), the partial histogram H₂ stored in the information processor A₃ is transferred to the information processor A₂, and is cumulatively added to the partial histogram H₂ stored in the information processor A₂.

During the period of the second transfer step from the time t=T/4 to the time t=2T/4, the histograms are transferred in parallel for process c (0, 2, 2), process c (1, 3, 3), process c (2, 0, 0) and process c (3, 1, 1), and cumulative addition is performed. In other words, in process c (0, 2, 2), the partial histogram H₂ stored in the information processor A₀ is transferred to the information processor A₂, and is cumulatively added to the partial histogram H₂ stored in the information processor A₂. In the process c (1, 3, 3), the partial histogram H₃ stored in the information processor A₁ is transferred to the information processor A₃, and is cumulatively added to the partial histogram H₃ stored in the information processor A₃. In process c (2, 0, 0), the partial histogram H₀ stored in the information processor A₂ is transferred to the information processor A₀, and is cumulatively added to the partial histogram H₀ stored in the information processor A₀. In. process c (3, 1, 1), the partial histogram H₁ stored in the information processor A₃ is transferred to the information processor A₁, and is cumulatively added to the partial histogram H₁ stored in the information processor A₁.

During the period of the third transfer step from the time t=2T/4 to the time t=3T/4, the histograms are transferred in parallel for process c (0, 1, 1), process c (1, 2, 2), process c (2, 3, 3) and process c (3, 0, 0), and cumulative addition is performed. In other words, in process c (0, 1, 1), the partial histogram H₁ stored in the information processor A₀ is transferred to the information processor A₁, and is cumulatively added to the partial histogram H₁ stored in the information processor A₁. In process c (1, 2, 2), the partial histogram H₂ stored in the information processor A₁ is transferred to the information processor A₂, and is cumulatively added to the partial histogram H₂ stored in the information processor A₂. In process c (2, 3, 3), the partial histogram H₃ stored in the information processor A₂ is transferred to the information processor A₃, and is cumulatively added to the partial histogram H₃ stored in the information processor A₃. In process c (3, 0, 0), the partial histogram H₀ stored in the information processor A₃ is transferred to the information processor A₀, and is cumulatively added to the partial histogram H₀ stored in the information processor A₀.

As a result, the partial histogram H₀ stored in the information processor A₀ at the time t=3T/4 is the sum of all the partial histograms H₀ separately stored in the four information processors A₀-A₃ at the time t=0. The partial histogram H₁ which is stored in the information processor A₁ at the time t=3T/4 is the sum of all the partial histograms H₁ separately stored in the four information processors A₀-A₃ at the time t=0. The partial histogram H₂ stored in the information processor A₂ at the time t=3T/4 is the sum of all the partial histograms H₂ separately stored in the four information processors A₀-A₃ at the time t=0. The partial histogram H₃ stored in the information processor A₃ at the time t=3T/4 is the sum of all the partial histograms H₃ separately stored in the four information processors A₀-A₃ at the time t=0.

Then the processes in steps S5₀-S5₃ are performed in parallel, and the image reconstruction is performed based on the partial histograms Hₙ stored in their respective information processors Aₙ.

Thus, according to the first embodiment, the time required for integrating each partial histogram is 3T/4. Generally, if each of the N number of information processors A₀-A_{N-1} divides a histogram into N number of partial histograms H₀-H_{N-1} and stores these partial histograms, the time required for integrating each of the N number of partial histograms H₀-H_{N-1} is (N−1)T/N.

### Second Embodiment

The second embodiment of the present invention will now be described. In the second embodiment, the three-dimensional PET equipment 1, the same as the first embodiment, is used. However in the second embodiment, an image processing method which is distinct from the first embodiment is used. In the present embodiment as well, the image processing system 2 includes the four information processors A₀-A₃. Each information processor Aₙ stores the partial histograms H₀-H₃ generated by equally dividing the original histogram into four.

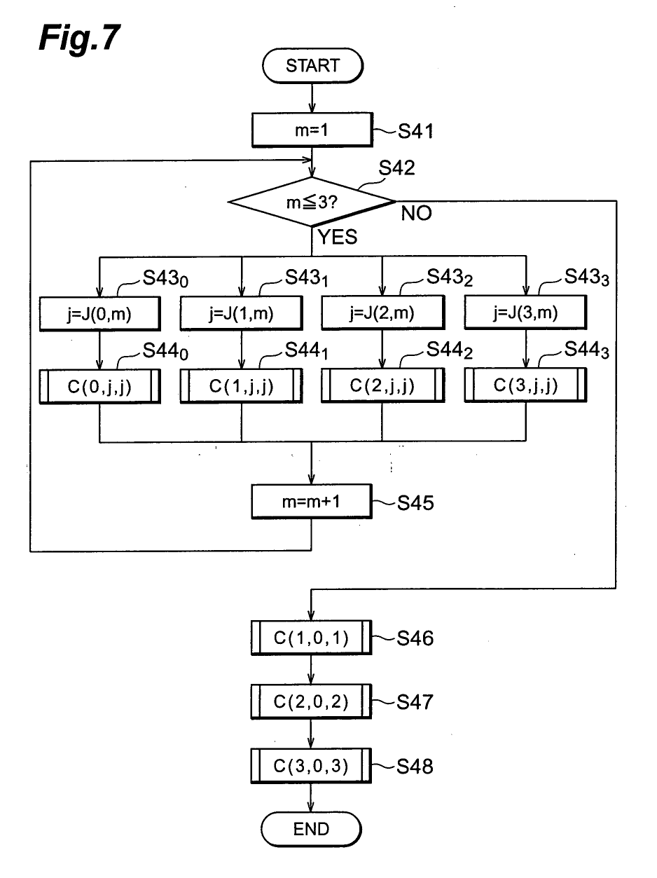

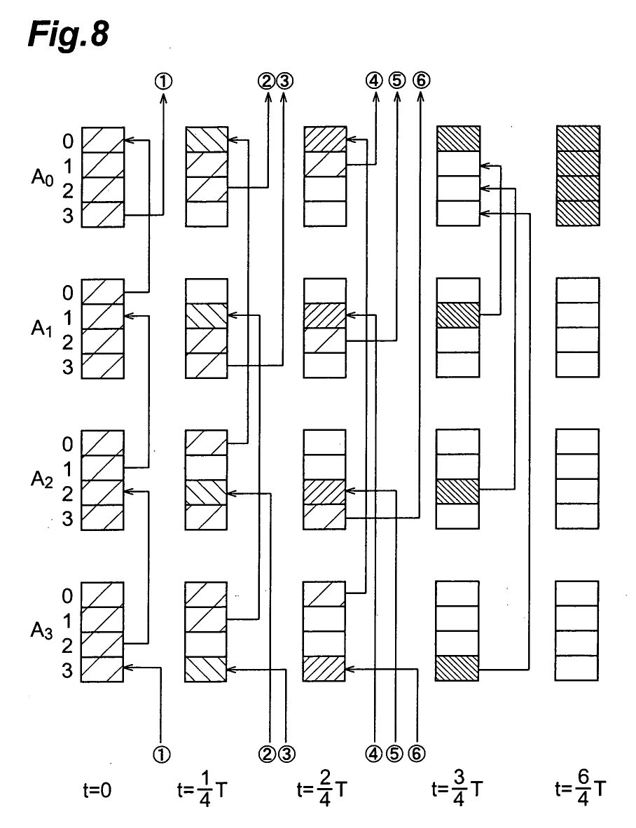

In the operation of the image processing system 2 of the present embodiment shown in FIG. 7 and FIG. 8, a process of transferring the partial histograms Hₙ stored in their respective information processors Aₙ to the information processor A₀ to integrate the transferred partial histograms Hₙ is added after step S4 in FIG. 3. FIG. 7 is a flow chart depicting the operation of the image processing system 2 according to the present embodiment. FIG. 8 is a diagram depicting the histogram transfer in the present embodiment. In the second embodiment, the histogram integration process including steps S46-S48 is executed after the processes up to the time t=3T/4 in the first embodiment.

More specifically, during the period from the time t=3T/4 to the time t=4T/4, process c (1, 0, 1) is executed in step S46. In other words, the partial histogram H₁ stored in the information processor A₁ is transferred to the information processor A₀, and stored in the information processor A₀ as the partial histogram H₁. Process c (2, 0, 2) is executed in step S47 during the period from the time t=4T/4 to the time t=5T/4. In other words, the partial histogram H₂ stored in the information processor A₂ is transferred to the information processor A₀, and stored in the information processor A₀ as the partial histogram H₂. Processing c (3, 0, 3) is executed in step S48 during the period from the time t=5T/4 to the time t=6T/4. In other words, the partial histogram H₃ stored in the information processor A₃ is transferred to the information processor A₀, and stored in the information processor A₀ as the partial histogram H₃.

As a result, at the time t=6T/4, all the partial histograms H₀-H₃ are integrated and stored in the information processor A₀. Then the image reconstruction is performed based on the partial histograms H₀-H₃ stored in this information processor A₀.

Thus, according to the second embodiment, the time required for integrating all the partial histograms is 6T/4. Generally, when each of the N number of information processors A₀-A_{N-1} divides the histogram into N number of partial histograms H₀-H_{N-1} and stores them, the time required for integrating all the partial histograms is 2(N−1)T/N.

### Third Embodiment

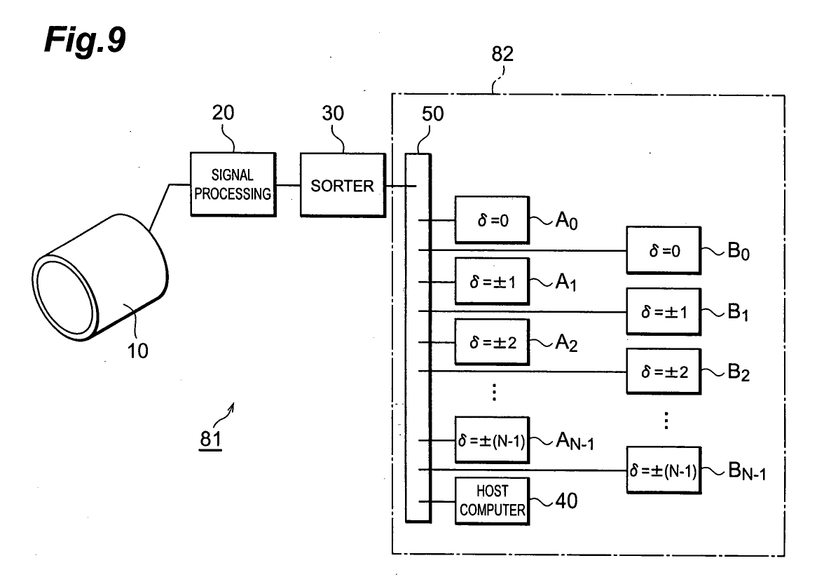

The third embodiment of the present invention will now be described. The third embodiment is the three-dimensional PET equipment 81 shown in FIG. 9. The PET equipment 81 have a detection section 10, signal processing section 20, sorter section 30, and image processing system 82. The detection section 10, signal processing section 20 and sorter section 30 are as described above. The image processing system 82 includes N number of the information processors A₀-A_{N-1}, and host computer 40 and switching hub 50. The image processing system 82 also includes N number of information processors B₀-B_{N-1} in addition to the information processors A₀-A_{N-1}. The information processors A₀-A_{N-1}, information processors B₀-B_{N-1} and the host computer 40 are inter-connected via the switching hub 50.

The operation of the image processing system 82 will now be described. Here it is assumed that the image processing system 82 includes the four information processors A₀-A₃ and the four information processors B₀-B₃. In each image information processor Aₙ, the partial histograms H₀-H₃ generated by equally dividing the original histogram into four.

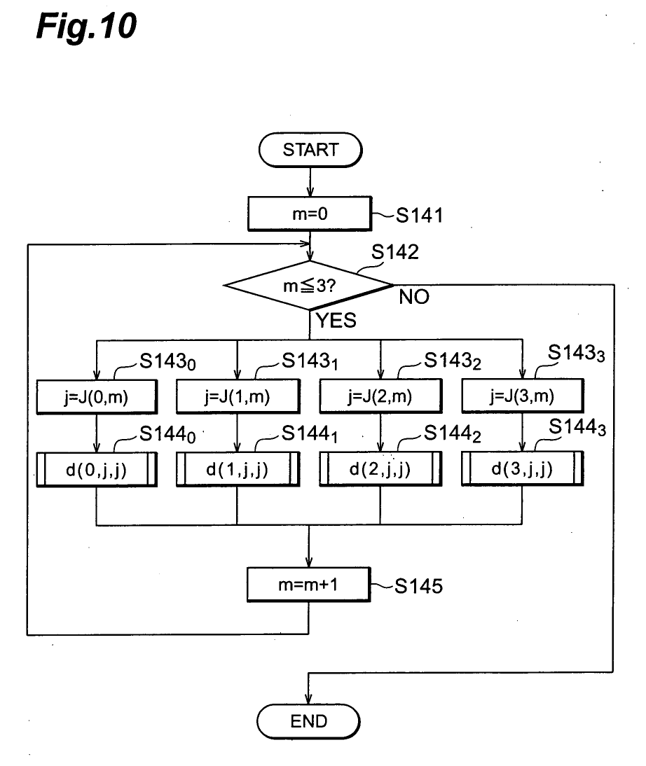

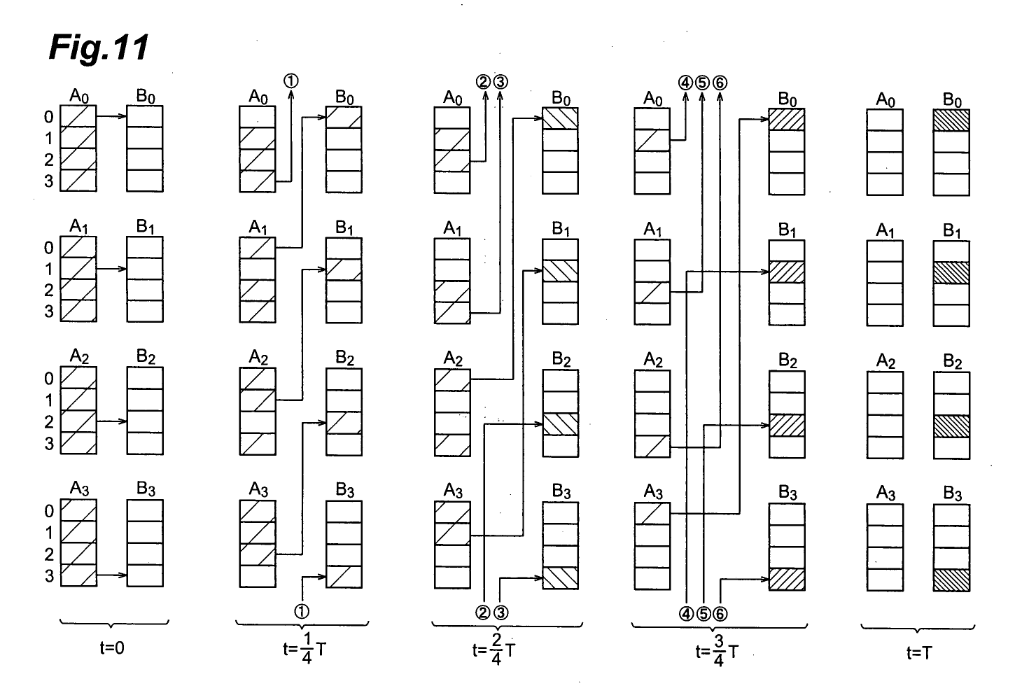

The PET equipment 81 uses an image processing method which is distinct from those in the first and second embodiments. The image processing of the present embodiment will now be described with reference to FIG. 10 and FIG. 11. FIG. 10 is a flow chart depicting the operation of the image processing system 82 according to the present embodiment. FIG. 11 is a diagram depicting the histogram transfer in the present embodiment.

The processes shown in steps S144₀-S144₃ in FIG. 10 can generally be represented by d (i, j, k). Process d (i, j, k) is a process of transferring the k-th partial histogram Hₖ stored in the i-th information processor Aᵢ to the j-th information processor Bⱼ, and cumulatively adding the transferred k-th partial histogram Hₖ to the k-th partial histogram Hₖ stored in the j-th information processor Bⱼ, where i, j and k are an integer from 0 to 3, respectively.

In FIG. 11, each row indicates a set of information processors A₀ and B₀, a set of A₁ and B₁, a set of A₂ and B₂, and a set of A₃ and B₃ respectively from the top, and each column indicates the time t=0, T/4, 2T/4 and 3T/4 respectively from the left. The two blocks in the p-th row and q-th column indicate a histogram which is stored in the set of information processors Aₚ and Bₚ at the time t=qT/4, where p is an integer that satisfies 0≦p≦3, and q is an integer that satisfies 0≦q≦4. Each block is displayed darker each time a histogram is cumulatively added. The information processor that has sent a histogram out may continue to store this histogram, however, in FIG. 11, the block indicating the information processor that has sent a histogram out is shown as a blank for clearness. The above mentioned time T is time required for transferring all the histograms stored in one information processor to other information processors. The time required for the internal process (the histogram cumulative addition process) of each information processor is ignored, since this is much smaller than the above mentioned time T.

At the time t=0, all the processes in steps S3₀-S3₃ have been completed, and the histogram stored in each information processor Aₙ has been equally divided into four partial histograms H₀-H₃. Then the processing is performed according to the flow shown in FIG. 10. In step S141, the value m is set to 0, and after step S142, steps S143₀-S143₃ are executed in parallel. Steps S144₀-S144₃ are also executed in parallel, then in step S145, the value m is incremented by 1, and the processing returns to step S142. The m-th transfer step (m=0, 1, 2 or 3) includes steps S143₀-S143₃ and steps S144₀-S144₃.

During the period of the O-th transfer step from the time t=0 to the time t=T/4, the histograms are transferred in parallel for process d (0, 0, 0), process d (1, 1, 1), process d (2, 2, 2) and process d (3, 3, 3). In other words, in process d (0, 0, 0), the partial histogram H₀ stored in the information processor A₀ is transferred to the information processor B₀, and stored in the information processor B₀ as the partial histogram H₀. In process d (1, 1, 1) the partial histogram H₁ stored in the information processor A₁ is transferred to the information processor B₁, and stored in the information processor B₁ as the partial histogram H₁. In process d (2, 2, 2), the partial histogram H₂ stored in the information processor A₂ is transferred to the information processor B₂, and stored in the information processor B₂ as the partial histogram H₂. In process d (3, 3, 3), the partial histogram H₃ stored in the information processor A₃ is transferred to the information processor B₃, and stored in the information processor B₃ as the partial histogram H₃.

During the period of the first transfer step from the time t=T/4 to the time t=2T/4, the histograms are transferred in parallel for process d (0, 3, 3), process d (1, 0, 0), process d (2, 1, 1) and process d (3, 2, 2), and cumulative addition is performed. In other words, in process d (0, 3, 3), the partial histogram H₃ stored in the information processor A₀ is transferred to the information processor B₃, and is cumulatively added to the partial histogram H₃ stored in the information processor B₃. In process d (1, 0, 0), the partial histogram H₀ stored in the information processor A₁ is transferred to the information processor B₀, and is cumulatively added to the partial histogram H₀ stored in the information processor B₀. In process d (2, 1, 1), the partial histogram H₁ stored in the information processor A₂ is transferred to the information processor B₁, and is cumulatively added to the partial histogram H₁ stored in the information processor B₁. In process d (3, 2, 2), the partial histogram H₂ stored in the information processor A₃ is transferred to the information processor B₂, and is cumulatively added to the partial histogram H₂ stored in the information processor B₂.

During the period of the second transfer step from the time t=2T/4 to the time t=3T/4, the histograms are transferred in parallel for process d (0, 2, 2), process d (1, 3, 3), process d (2, 0, 0) and process d (3, 1, 1), and cumulative addition is performed. In other words, in process d (0, 2, 2), the partial histogram H₂ stored in the information processor A₀ is transferred to the information processor B₂, and is cumulatively added to the partial histogram H₂ stored in the information processor B₂. In the process d (1, 3, 3), the partial histogram H₃ stored in the information processor A₁ is transferred to the information processor B₃, and is cumulatively added to the partial histogram H₃ stored in the information processor B₃. In process d (2, 0, 0), the partial histogram H₀ stored in the information processor A₂ is transferred to the information processor B₀, and is cumulatively added to the partial histogram H₀ stored in the information processor B₀. In process d (3, 1, 1), the partial histogram H₁ stored in the information processor A₃ is transferred to the information processor B₁, and is cumulatively added to the partial histogram H₁ stored in the information processor B₁.

During the period of the third transfer step from the time t=3T/4 to the time t=T, the histograms are transferred in parallel for process d (0, 1, 1), process d (1, 2, 2), process d (2, 3, 3) and process d (3, 0, 0), and cumulative addition is performed. In other words, in process d (0, 1, 1), the partial histogram H₁ stored in the information processor A₀ is transferred to the information processor B₁, and is cumulatively added to the partial histogram H₁ stored in the information processor B₁. In process d (1, 2, 2), the partial histogram H₂ stored in the information processor A₁ is transferred to the information processor B₂, and is cumulatively added to the partial histogram H₂ stored in the information processor B₂. In process d (2, 3, 3), the partial histogram H₃ stored in the information processor A₂ is transferred to the information processor B₃, and is cumulatively added to the partial histogram H₃ stored in the information processor B₃. In process d (3, 0, 0), the partial histogram H₀ stored in the information processor A₃ is transferred to the information processor B₀, and is cumulatively added to the partial histogram H₀ stored in the information processor B₀.

As a result, the partial histogram H₀ stored in the information processor B₀ at the time t=T is the sum of all the partial histograms H₀ separately stored in the four information processors A₀-A₃ at the time t=0. The partial histogram H₁ stored in the information processor B₁ at the time t=T is the sum of all the partial histograms H₁ separately stored in the four information processors A₀-A₃ at the time t=0. The partial histogram H₂ stored in the information processor B₂ at the time t=T is the sum of all the partial histograms H₂ separately stored in the four information processors A₀-A₃ at the time t=0. The partial histogram H₃ stored in the information processor B₃ at the time t=T is the sum of all the partial histograms H₃ separately stored in the four information processors A₀-A₃ at the time t=0. Then the image reconstruction processes are executed in parallel in the four information processors B₀-B₃, respectively.

Thus, according to the third embodiment, the time required for integrating each partial histogram is T. This required time T does not depend on the number N of the information processors A₀-A_{N-1}.

When comparing the processing time for the histogram transfer in the first, second and third embodiments with that in the prior art, the following result is obtained. The required time is (N−1)T/N in the first embodiment, 2(N−1)T/N in the second embodiment, T in the third embodiment, and (N−1)T in the prior art. If N=16, the total size of the histogram is 100 MB, and the transfer speed is 10 MB/s, then the time T required for transferring the entire histogram is 10 seconds. In this case, the required time is 9.4 seconds in the first embodiment, 18.8 seconds in the second embodiment, 10 seconds in the third embodiment, and 150 seconds in the prior art.

Thus the image processing system and the image processing method according to the embodiments can shorten the time required for the histogram transfer. Radiation image measurement equipment including such an image processing system, such as three-dimensional PET equipment can improve the throughput in measuring samples.

The present invention has been explained in detail hereinabove based on the embodiments thereof. However, the present invention is not limited to the embodiments, and various modifications may be possible without departing from the scope thereof.

The image processing program according to an embodiment of the present invention is a program for having a computer execute one of the above mentioned image processing methods. The recording medium according to an embodiment of the present invention is a computer readable recording medium, such as a CD-ROM or DVD-ROM, on which such an image processing program is recorded. The host computer 40 executes one of the above mentioned image processing methods according to the image processing program stored on the hard disk of the host computer 40 itself, or the image processing program recorded on the recording medium.

The image processing program according to an embodiment of the present invention may be included in a computer data signal embodied in a carrier wave. In this case, the host computer 40 executes one of the above image processing methods according to the image processing program included in the computer data signal. The host computer can receive the computer signal via communication networks.

In the above embodiments, the three-dimensional PET equipment is used as the radiation image measurement equipment according to the present invention. Alternately, two-dimensional PET equipment, a y camera or SPECT may be used. In the case of a y camera or SPECT, the signal processing section 20 can determine whether the arrival of radiation, detected by the radiation detector, is an effective event using the energy difference.

### Industrial Applicability

As described above, the i-th partial histogram Hᵢ cumulatively added at the i-th information processor Aᵢ by the first to (N−1)-th transfer means is the sum of all the i-th partial histograms Hᵢ stored in the information processors A₀-A_{N-1} before the cumulative addition. The first to (N−1)-th transfer means transfer a plurality of partial histograms in parallel, so that the time required for the histogram transfer will be shortened.

Thus the present invention is able to realize an image processing in which the time required for the histogram transfer is shortened.

1-15. (canceled)

16. An image processing system, comprising:
N number of information processors A₀-A_{N-1} (N is an integer of 2 or more) each of which divides one histogram into N number of partial histograms H₀-H_{N-1} and stores these partial histograms;
first to (N−1)-th transfer means for transferring the partial histograms in parallel between the information processors A₀-A_{N-1} to cumulatively add the partial histograms; and
image processing means for performing an image process based on the partial histograms H₀-H_{N-1} cumulatively added at the information processors A₀-A_{N-1}, respectively, by the first to (N−1)-th transfer means,
the m-th transfer means (m is an integer from 1 to N−1) executing process c (0, J (0, m), J (0, m)), process c (1, J (1, m), J (1, m)), . . . , process c (N−1, J (N−1, m), J (N−1, m)) while transferring the J (0, m)-th, J (1, m)-th, . . . , J (N−1, m)-th partial histograms in parallel, where c (i, j, k) indicates a process of transferring the k-th partial histogram Hₖ stored in the i-th information processor Aᵢ to the j-th information processor Aⱼ to cumulatively add the transferred partial histogram Hₖ to the k-th partial histogram Hₖ stored in the j-th information processor Aⱼ, i, j and k are integers from 0 to N−1, J (n, m)=(n−m)% N, and % is a modulo operator.

17. The image processing system according to claim 16, further comprising histogram integration means for integrating the partial histograms H₀-H_{N-1}, cumulatively added at the information processors A₀-A_{N-1}, respectively, by the first to (N−1)-th transfer means, to one of the information processors A₀-A_{N-1,}
wherein the image processing means performs the image process based on the partial histograms H₀-H_{N-1} integrated to the one of the information processors by the histogram integration means.

18. The image processing system according to claim 16, wherein the image processing means performs, in parallel, a plurality of the image processes based on their respective partial histograms H₀-H_{N-1} cumulatively added by the first to (N−1)-th transfer means.

19. The image processing system according to claim 16, wherein the one histogram includes radiation generation frequency data, and
wherein the image processing means reconstructs an image representing a spatial distribution of the radiation generation frequency based on the partial histograms H₀-H_{N-1} cumulatively added by the first to (N−1)-th transfer means.

20. Radiation image measurement equipment, comprising:
a detection section having a plurality of radiation detectors for detecting arrival of radiation from a measurement space;
a signal processing section for determining whether the arrival of radiation detected by one of the radiation detectors is an effective event, and outputting data including information on the arrival of radiation determined as an effective event; and
the image processing system according to claim 16,
wherein, when the data is output from the signal processing section, the information processor selected from the information processors A₀-A_{N-1} receives the data from the signal processing section, and
wherein each of the information processors A₀-A_{N-1} generates the partial histograms H₀-H_{N-1} based on the data received from the signal processing section, and stores these partial histograms.

21. The radiation image measurement equipment according to claim 20, wherein the detection section has a plurality of detector rings stacked along the axis direction, each detector ring including the radiation detectors arranged in a ring shape, identification numbers being assigned to the detector rings sequentially along the axis direction,
wherein determining whether the arrival of radiation is an effective event includes determining whether a pair of photons which are generated by pair annihilation of an electron and a positron and travel in opposite directions have been detected by a pair of the radiation detectors, and
wherein, when it is determined that a pair of photons have been detected by a pair of the radiation detectors, the signal processing section outputs a coincidence counting data that identifies the pair of the radiation detectors,
the radiation image measurement equipment further comprising a sorter interposed between the signal processing section and the image processing system,
the sorter receiving the coincidence counting data from the signal processing section to select one of the information processors A₀-A_{N-1} according to the difference between the identification numbers of one or more of the detector rings including the pair of the radiation detectors, and send the coincidence counting data to the selected information processor,
each of the information processors A₀-A_{N-1} producing the partial histograms H₀-H_{N-1} based on the coincidence counting data sent from the sorter, and storing these partial histograms.

22. An image processing system, comprising:
N number of information processors A₀-A_{N-1} (N is an integer of 2 or more) each of which divides one histogram into N number of partial histograms H₀-H_{N-1} and stores these partial histograms;
N number of information processors B₀-B_{N-1} which are distinct from the information processors A₀-A_{N-1};
first to (N−1)-th transfer means for transferring the partial histograms in parallel between the information processors A₀-A_{N-1} and B₀-B_{N-1} to cumulatively add the partial histograms; and
image processing means for performing an image process based on the partial histograms H₀-H_{N-1} cumulatively added at the information processors B₀-B_{N-1}, respectively, by the first to (N−1)-th transfer means,
wherein the m-th transfer means (m is an integer from 1 to N−1) executing process d (0, J (0, m), J (0, m)), process d (1, J (1, m), J (1, m)), . . . , process d (N−1, J (N−1, m), J (N−1, m)) while transferring the J (0, m)-th, J (1, m)-th, . . . , J (N−1, m)-th partial histograms in parallel, where d (i, j, k) indicates a process of transferring the k-th partial histogram Hₖ stored in the i-th information processor Aᵢ to the j-th information processor Bⱼ to cumulatively add the transferred partial histogram Hₖ to the k-th histogram Hₖ stored in the j-th information processor Bⱼ, i, j and k are integers from 0 to N−1, J (n, m)=(n−m)% N, and % is a modulo operator.

23. The image processing system according to claim 22, wherein the image processing means performs, in parallel, a plurality of the image processes based on their respective partial histograms H₀-H_{N-1} cumulatively added by the first to (N−1)-th transfer means.

24. The image processing system according to claim 22, wherein the one histogram includes radiation generation frequency data, and
wherein the image processing means reconstructs an image representing a spatial distribution of the radiation generation frequency based on the partial histograms H₀-H_{N-1} cumulatively added by the first to (N−1)-th transfer means.

25. Radiation image measurement equipment, comprising:
a detection section having a plurality of radiation detectors for detecting arrival of radiation from a measurement space;
a signal processing section for determining whether the arrival of radiation detected by one of the radiation detectors is an effective event, and outputting data including information on the arrival of radiation determined as an effective event; and
the image processing system according to claim 22,
wherein, when the data is output from the signal processing section, the information processor selected from the information processors A₀-A_{N-1} receives the data from the signal processing section, and
wherein each of the information processors A₀-A_{N-1} generates the partial histograms H₀-H_{N-1} based on the data received from the signal processing section, and stores these partial histograms.

26. The radiation image measurement equipment according to claim 25, wherein the detection section has a plurality of detector rings stacked along the axis direction, each detector ring including the radiation detectors arranged in a ring shape, identification numbers being assigned to the detector rings sequentially along the axis direction,
wherein determining whether the arrival of radiation is an effective event includes determining whether a pair of photons which are generated by pair annihilation of an electron and a positron and travel in opposite directions have been detected by a pair of the radiation detectors, and
wherein, when it is determined that a pair of photons have been detected by a pair of the radiation detectors, the signal processing section outputs a coincidence counting data that identifies the pair of the radiation detectors,
the radiation image measurement equipment further comprising a sorter interposed between the signal processing section and the image processing system,
the sorter receiving the coincidence counting data from the signal processing section to select one of the information processors A₀-A_{N-1} according to the difference between the identification numbers of one or more of the detector rings including the pair of the radiation detectors, and send the coincidence counting data to the selected information processor,
each of the information processors A₀-A_{N-1} producing the partial histograms H₀-H_{N-1} based on the coincidence counting data sent from the sorter, and storing these partial histograms.

27. An image processing method for performing an image process using N number of information processors A₀-A_{N-1} each of which divides one histogram into N number of partial histograms H₀-H_{N-1} (N is an integer of 2 or more) and stores these partial histograms, comprising:
first to (N−1)-th transferring the partial histograms in parallel between the information processors to cumulatively add the partial histograms; and
performing an image process based on the partial histograms H₀-H_{N-1} cumulatively added at the information processors A₀-A_{N-1}, respectively, by the first to (N−1)-th transferring the partial histograms,
the m-th transferring the partial histograms (m is an integer from 1 to N−1) includes executing process c (0, J (0, m), J (0, m)), process c (1, J (1, m), J (1, m)), . . . , process c (N−1, J (N−1, m), J (N−1, m)) while transferring the J (0, m)-th, J (1, m)th, . . . , J (N−1, m)-th partial histograms in parallel, where c (i, j, k) indicates a process of transferring the k-th partial histogram Hₖ stored in the i-th information processor Aᵢ to the j-th information processor Aⱼ to cumulatively add the transferred partial histogram Hₖ to the k-th partial histogram Hₖ stored in the j-th information processor Aⱼ, i, j, and k are integers from 0 to N−1, J (n, m)=(n−m)% N, and % is a modulo operator.

28. The image processing method according to claim 27, further comprising integrating the partial histograms H₀-H_{N-1}, cumulatively added at the information processors A₀-A_{N-1}, respectively, by the first to (N−1)-th transferring the partial histograms, to one of the information processors A₀-A_{N-1},
wherein the performing the image process includes performing the image process based on the partial histograms H₀-H_{N-1} integrated to the one of the information processors.

29. The image processing method according to claim 27, wherein the performing the image process includes performing, in parallel, a plurality of the image processes based on their respective partial histograms H₀-H_{N-1} cumulatively added by the first to (N−1)-th transferring the partial histograms.

30. The image processing method according to claim 27, wherein the one histogram includes radiation generation frequency data, and
wherein the performing the image process includes reconstructing an image representing a spatial distribution of the radiation generation frequency based on the partial histograms H₀-H_{N-1} cumulatively added by the first to (N−1)-th transferring the partial histograms.

31. An image processing program for having a computer execute the image processing method according to claim 27.

32. A computer-readable recording medium on which an image processing program is recorded for having a computer execute the image processing method according to claim 27.

33. A computer data signal embodied in a carrier wave, comprising an image processing program for having a computer execute the image processing method according to claim 27.

34. An image processing method for performing an image process using N number of information processors A₀-A_{N-1} each of which divides one histogram into N number of partial histograms H₀-H_{N-1} (N is an integer of 2 or more) and stores these partial histograms, and N number of information processors B₀-B_{N-1} which are distinct from the information processors A₀-A_{N-1}, comprising:
first to (N−1)-th transferring the partial histograms in parallel between the information processors to cumulatively add the partial histograms; and
performing an image process based on the partial histograms H₀-H_{N-1} cumulatively added at the information processors B₀-B_{N-1}, respectively, by the first to (N−1)-th transferring the partial histograms,
the m-th transferring the partial histograms (m is an integer from 1 to N−1) includes executing process d (0, J (0, m), J (0, m)), process d (1, J (1, m), J (1, m)), . . . , process d (N−1, J (N−1, m), J (N−1, m)) while transferring the J (0, m)-th, J (1, m)-th, . . . , J (N−1, m)-th partial histograms in parallel, where d (i, j, k) indicates a process of transferring the k-th partial histogram Hₖ stored in the i-th information processor Aᵢ to the j-th information processor Bⱼ to cumulatively add the transferred partial histogram Hₖ to the k-th partial histogram Hₖ stored in the j-th information processor Bⱼ, i, j and k are integers from 0 to N−1, J (n, m)=(n−m)% N, and % is a modulo operator.

35. The image processing method according to claim 34, wherein the performing the image process includes performing, in parallel, a plurality of the image processes based on their respective partial histograms H₀-H_{N-1} cumulatively added by the first to (N−1)-th transferring the partial histograms.

36. The image processing method according to claim 34, wherein the one histogram includes radiation generation frequency data, and
wherein the performing the image process includes reconstructing an image representing a spatial distribution of the radiation generation frequency based on the partial histograms H₀-H_{N-1} cumulatively added by the first to (N−1)-th transferring the partial histograms.

37. An image processing program for having a computer execute the image processing method according to claim 34.

38. A computer-readable recording medium on which an image processing program is recorded for having a computer execute the image processing method according to claim 34.

39. A computer data signal embodied in a carrier wave, comprising an image processing program for having a computer execute the image processing method according to claim 34.
